(19) United States
(12) Patent Application Publication
(10) Pub. No.: US 2016/0183504 A1
(43) Pub. Date: Jun. 30, 2016

(54) SPINNER CRANK FISHING LURE

(71) Applicant: Jason Curtis, Denham Springs, LA (US)

(72) Inventor: Jason Curtis, Denham Springs, LA (US)

(21) Appl. No.: 14/865,003

(22) Filed: Sep. 25, 2015

Related U.S. Application Data
(60) Provisional application No. 62/055,291, filed on Sep. 25, 2014.

(51) Int. Cl. A01K 85/10

(52) U.S. Cl. CPC A01K 85/10

(57) ABSTRACT

A fishing lure and method for its use are described. The fishing lure includes a lure body made from a buoyant material having a spinner assembly attached to its back end, and an optional wobble plate attached to its front end. The spinner assembly includes a rigid blade, typically metallic, adapted to freely rotate 360 degrees in a conical pattern behind the lure body as the lure is pulled through the water. Typical lure bodies include, but are not limited to crank baits and shad baits.

### CROSS-REFERENCES TO RELATED APPLICATIONS

This application claims the benefit of U.S. Provisional Patent Application No. 62/055,291, filed Sep. 25, 2014, entitled SPINNER CRANK FISHING LURE, which is incorporated herein by reference.

### BACKGROUND OF THE INVENTION

1. Field of the Invention

This specification relates to a fishing lure, and more particularly, to a fishing lure that includes a lure body and spinner element design which can be used in buzz bait, spinner bait or crank bait lure configurations.

2. Background

Various fishing lures have been used to attract fish thereto so as to hook a fish striking the lure. Such lures can be generally categorized into jigs, spinners, spoons, soft plastic baits, plugs, spinnerbaits, and flies.

Jigs consists of a weighted head and are often dressed or skirted with feathers, hair, a soft plastic grub, or bait. Spinner bait lures do not have a dressing and are designed for use under the surface of the water and can be described as a metal shaft with a spinning blade or spoon. The rotation results from the pulling of the concave blade or spoon through the water.

Soft plastic baits encompass a variety of different lures and are typically shaped to mimic a natural forage of the desired fish. Often also resembling natural forage, plugs are constructed from hollow plastic or wood to resemble baitfish, frogs or other prey. They usually sport two or three treble hooks. These hard bodied lures can be fished at almost any depth, as some are made to float or dive or both. Depending on the design, a plug can wobble, rattle or gurgle.

Spinnerbaits and buzzbaits are awkward looking lures, consisting of a safety-pin like wire attached to a lead head body. The body usually is dressed with a rubber skirt and the arm with one or two metallic blades like those seen on spinners. Alternatively, spinnerbaits can be said to resemble the union via a safety pin of a jig and a spinner.

Flies are very light lures that imitate insects or other natural prey in various stages of the prey's life cycle. Examples of such prey include baitfish, leeches, hoppers or mice and frogs. Flies are usually constructed of fur and feathers, though some patterns make use of new materials like foam and rubber.

Lures are typically designed to create some sort of sensory event that attracts and encourages a fish to strike the lure. However, natural prey also exhibit certain behaviors that can attract fish. Examples of such natural behaviors include slow, meandering diving, neutrally buoyant behaviors such suspension beneath the service, and diving actions substantially different than ascending actions. Currently available lures typically mimic individual movements aspects associated with a potential prey. What is needed is a lure that can mimic combined aspects of a prey's movements, such as a small fish's natural swimming motions and additionally provide a wake behind the lure typical of that produced by a swimming fish. The current disclosure addresses this need.

### SUMMARY

This specification describes technologies relating to a fishing lure having a combination plug base and a spinner attachment capable of mimicking the swimming motion of a fish.

A fishing lure according to one aspect of the present invention relates to a lure with a lure body having a first and second end, and the general form of a shad or crank bait lure. The lure body can have a wobble plate attached to the first end of the lure body and a spinner assembly attached to the second end of the lure body. The spinner attachment is pivotally and detachably attached to the lure body so that the spinner blade can freely rotate and pivot in any direction with respect to the shad, crank bait, or other body creating a wake following the lure. During forward motion of the lure, i.e., being pulled, the spinner repeatedly spins in a generally conical pattern and the spinner assembly pivots in a direction opposed to the movement of the lure as a whole in a generally conical pattern. Such pivoting movement of the spinner assembly mimics the swimming movement of a small fish's tail. Examples of suitable blades include, but are not limited to Colorado blades, Indiana blades, and other leaf blades. Generally, a spinner assembly utilized alone spins and moves in a straight line in the direction it's pulled. A shad or crank bait lure equipped with a wobble plate typically moves in the direction its pulled with a side-to-side motion or a diving motion, but fails to create an undulating or oscillating motion typical of a fish swimming.

The combination of the lure body and a spinner assembly surprisingly interact in an unexpected manner to mimic the undulating swimming motion of a fish, including creating a wake following the lure. A lure body including a wobble plate typically pivots from side to side and/or dives up and down depending on the wobble plates shape. As the lure body pivots the spinner assembly acts as a drag on the lure body causing the combination to undulate or oscillate from side to side or up and down creating a wake similar to that caused by the swimming motion of a fish. Because the spinner creates a drag on the lure's body, the wobble motion is slightly restricted and coordinated with the movements of the lure body. Thus the combination of the lure body and the spinner assembly cooperate to mimic a small swimming fish, including creating a wake behind the spinner assembly. A wide range of lure sizes can be produced for a fish having a range of sizes. As a result of this unexpected motion, the lure has proven highly productive in catching salt water and fresh water fish ranging from bluegill, crappie, bass, northern pike, redfish, speckled trout, and the like.

The fishing lure, according to another aspect of the present invention, relates to shad or crank bait like lure with a spinner attachment wherein the shad or crank bait portion is positively buoyant while the spinner attachment is negatively buoyant. Depending on the density of the spinner attachment, the fishing lure can be have a density less than water, substantially equal to water, or more dense than water such that a given combination can float, remain suspended at any given depth, or sink to the bottom of the body of water. Depending on the density of the fishing lure, during rest, i.e., not being pulled, the combination lure can float, remain at the depth achieved upon being cast, or sink in reverse to either come to rest substantially on the bottom of the body of water. In either event, the shad or crank bait portion of the lure floats above the spinner portion in an upright and natural manner. That is, the shad or crank bait floats above the spinner portion with the lure's spinner end lower than the lure body's first end, the shad or crank bait portion further floats in a natural or upright manner due to the additional weight of one or more hooks attached to the lure body forcing the shad or crank bait portion to be upright. The effect can be said to mimic, to some degree, a small creature floating near the surface, just above the bottom of the body of water, or at intermediate levels depending on the density of the lure.

The fishing lure, according to another aspect of the present invention, relates to shad or crank bait lure with a spinner attachment. The shad lure has a shape corresponding to the body of a typical minnow, where as the crank bait lure has a top concave portion and a bottom leading concave portion with a trailing (ending) convex portion. The front of the lure body includes a wobble plate. The effect caused by the wobble plate is to impart, when being pulled through water, a random forward movement. Such random movement can include sideways movements with varying inhibition of the random movement being imposed from the drag of the spinner attachment. Some implementations have movement that can also include downward and upward movement.

The fishing lure according to one aspect of the present invention relates to a lure having a lure body composed of a buoyant material, the lure body having a first and second end, and a spinner assembly, including a rigid blade. The spinner assembly is coupled to the lure body's second end such that the rigid blade can freely rotate 360 degrees in a conical pattern behind the lure body as the lure body and attached spinner assembly is pulled through water. Rigid blades suitable for incorporation in the lure can include, but are not limited to a Colorado blades, Indiana blades, and other leaf blades. Lures according to the present invention have an eye located at the first end of the lure body for attaching a line and at least one hook is attached to the lure body. Certain lure bodies have a shape corresponding to a shad lure, a crank bait lure or other appropriate lure body with a wobble plate is affixed to the first end of the lure body. Lures according to the present invention can be configured to provide a lure body/spinner assembly combination having a combined density that is less than the density of water, equal to the density of water, or greater than the density of water. When such a lure is cast into a body of water, the rigid blade spins leading the lure body in sinking within the body of water. When a lure having a density equal to the density of water is cast into a body of water, the lure achieves a level based on its inertia and remains suspended in the water at that level until retrieved, whereupon the lure can move from side to side and/or dive with forward motion.

Certain lures can include hollow cavities into which threaded inserts can be detachably inserted to modify the density of the lure. Finally, lures can be painted to create a variety of patterns designed to attract the attention of fish and mimic a natural food source. Epoxy and polyurethane paints have proven particularly useful.

A further aspect of the present disclosure involves a method for fishing using a fishing lure as described above including providing such a lure, casting the lure into a body of water, and retrieving the lure, typically by reeling the lure in. Prior to retrieving the lure, the lure can be allowed to rest in the water. In retrieving the lure, it can be reeled in without interruption at a generally constant speed; at a range of different speeds, with an intermittent stop and start motion, or a combination thereof.

These and other embodiments can each optionally include one or more of the following features. The shad or crank bait portion of the fishing lure can include regions able to accept weighted inserts, the weighted inserts configured such that the center of gravity and center of buoyancy of the lure body can be altered as well as the overall buoyancy without substantially impacting the contour of the lure body. For example, the lure body can accept weighted threaded inserts that screw into the lure body so as to be flush with the surface of the lure body.

As noted above, the lure body of the fishing lure can also include a detachable wobble plate such that the wobble plate can be removed or alternatively, replaced with a larger or smaller wobble plate. This allows the effect of the wobble plate upon the lure body to be adjusted by the user through the utilization of different sized and/or shaped wobble plates.

Finally, aspects of the current disclosure can further involve fishing lures having a lure body that are not buoyant. Such lures are normally cast and reeled in without significant delay in the same manner as spoon and spinner lures. Such lures provide many of the advantages obtained from lures having a buoyant lure body.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a side representation of one implementation of the combination lure.

FIG. 2 is another side representation of an implementation of the combination lure capable of accepting threaded inserts.

FIG. 3 is an exploded representation of the shad body of the combination lure having a detachable wobble plate.

FIG. 4 is a side representation of one implementation of the combination lure.

FIG. 5 is a flow diagram illustrating one exemplary embodiment of a method for fishing using a fishing lure as described herein.

Like reference numbers and designations in the various drawings indicate like elements.

### DETAILED DESCRIPTION

Before the present methods, implementations and systems are disclosed and described, it is to be understood that this invention is not limited to specific synthetic methods, specific components, implementation, or to particular compositions, and as such may, of course, vary. It is also to be understood that the terminology used herein is for the purpose of describing particular implementations only and is not intended to be limiting.

As used in the specification and the claims, the singular forms “a,” “an” and “the” include plural referents unless the context clearly dictates otherwise. Ranges may be expressed in ways including from “about” one particular value, and/or to “about” another particular value. When such a range is expressed, another implementation may include from the one particular value and/or to the other particular value. Similarly, when values are expressed as approximations, for example by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. Similarly, “typical” or “typically” means that the subsequently described event or circumstance often though may not occur, and that the description includes instances where said event or circumstance occurs and instances where it does not.

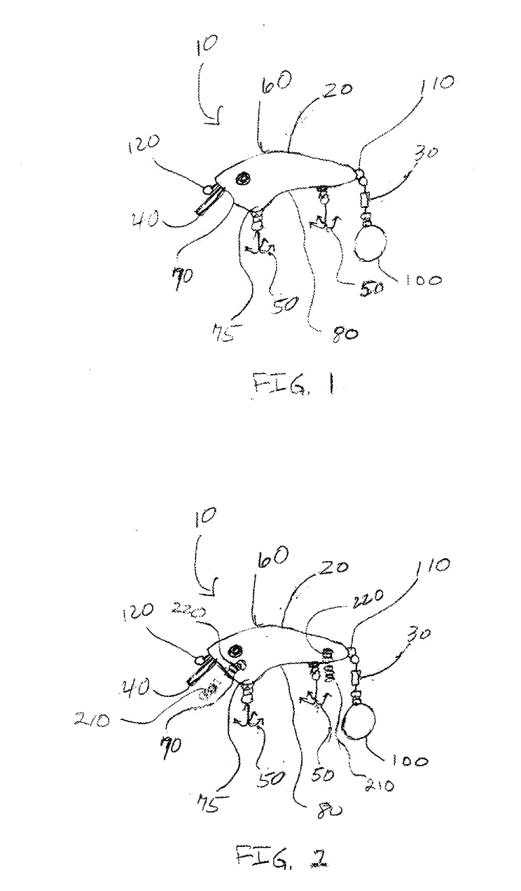

As shown in FIG. 1, one implementation of the fishing lure 10 (combination fishing lure) comprises a lure body 20 having a crank bait shape, a spinner attachment 30, a wobble plate 40, and fishing hooks 50. The lure body 20 is buoyantly positive. The lure body 20 is shaped such that the width (thickness) of the body is approximately equal to 12% to 25% of the length of the body. The entire assembly is weighted such that when allowed to sink within a body of water, the spoon or blade 100 (a Colorado blade) and some portion of the spinner assembly 30 will rest upon the bottom of the body of the water while the lure body 20 rest upright with the wobble plate 40 at a higher elevation than the spinner assembly attachment point 110. During such a resting state, the weight of the hooks 50 cause the lure body 20 to remain upright. That is to say that the lure body 20 floats just above the bottom of the body of water, at an angle such that the wobble plate 40 is higher in elevation than the spinner attachment point 110, while some portion of the spinner assembly 30 rests on the bottom of the body of water.

The lure body 20 has a concave top portion 60, a front portion 70, a bottom concave portion 75, and a rear convex portion 80. The lure body 20 is led by a wobble plate 40. The lure body 20 has a line attachment eye 120. When pulled through the water, the wobble plate 40 can generate a noise and cause some side to side movement. Additionally, when pulled through the water, the wobble plate 40 along with the combination of shapes of the lure body 20 create turbulence about the wobble plate causing the fishing lure 10 to wobble both in the horizontal plane as well as the vertical plane. The spinner assembly 30 works to add drag upon the overall assembly, creating turbulence or a wake, noise, and a flashing image which serves to provide a stimulus, both in terms of motion and sound, to attract fish. The drag serves to help mitigate the wobbling of the fishing lure 10 causing a more natural like overall behavior. The spoon 100 of the spinner assembly 30 rotates 360 degrees behind the lure body 20 and about an axis in a generally conical manner substantially parallel to that of the direction of pull upon the lure body 20.

The lure body 20 is composed of any suitable, buoyantly positive, or made buoyantly positive material. For example, the lure body 20 can be composed of plastic or plastic with hollow portions to enhance buoyancy. The example described lure body 20 can be produced through well-known plastic injection molding processes.

The spinner assembly 30 can be composed of any suitable, durable rigid material such that the spinner assembly 30 is not buoyant and readily sinks in water. For some embodiments, the spinner assembly should be weighted such that the entire lure 10 sinks, with the spinner assembly 30 pulling the rest of the lure 10 down to the bottom of the body of water. For other embodiments, the spinner assembly should be weighted to cause the lure's density to be less than the density of water, or substantially equal to the density of water so that the lure substantially floats or remains at an initial depth. Additionally, different spinner assemblies 30 incorporating one or more blades and/or different shaped blades will impart different behaviors. For example, a spinner assembly 30 incorporating a smaller blade can be configured to impart a smaller drag and density than that of a spinner assembly 30 incorporating a larger blade.

It should be understood that such spinner assemblies 30 are well understood in the art, enable the free rotation of the spoon 100 of the spinner assembly 30, and is not further elaborated upon within this document.

FIG. 2 is a representation of a second implementation of the lure 10 having the elements of the FIG. 1 and additionally having inserts 210 and corresponding hollow portions 220. While represented as threaded inserts 210, it should be understood that other means of inserting the inserts 210 into the lure body 20 exist and “threaded” should be understood as to impose no limitation upon the means of fixing the inserts into the shad body 20. For example, the inserts 210 could be sized such as to enable a pressure fitting, attachment utilizing an adhesive, or other attachment to the lure body 20. The inserts 210 can composed of any suitable material. Example materials include plastic, metal, and combinations thereof.

In some implementations, the inserts 210 are weighted such as to impart a user configurable behavior upon the lure 10. For example, the inserts 210 can be weighted such that the lure body 20 floats and the spinner assembly 30 is submerged while the lure is at rest, with the front portion of the lure body 20 pointed down towards the bottom of the body of water. In some implementations, the weights are such that the front portion of the shad body 20 will, essentially, point towards the horizon. That is, in some implementations, the inserts 210 will cause the shad body 20 to rest in a neutral position. As the weight of the spinner assembly is increased, the lure is positioned below the surface with each component positioned as described above.

Additionally, some implementations utilize a coating for the lure body 20 and optionally for the spinner assembly 30 known in the art to attract fish. For example, the coating may comprise an epoxy or a polyurethane suitable for underwater use. Said coating can be of various colors with effects, such as pearlescent, metallic flecks, glitter, or the like. Further, the coating can also comprise a scent or other visual or chemical attractant designed to enhance the appeal of the lure 10 to fish.

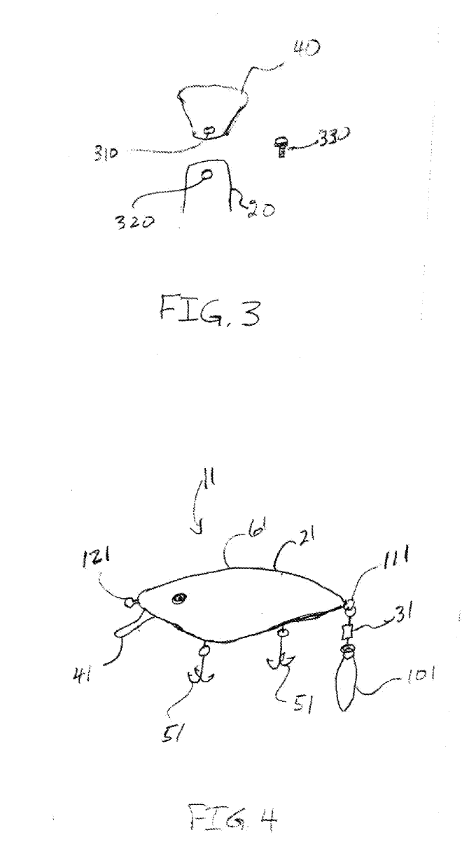

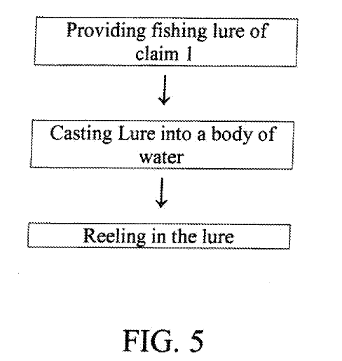

FIG. 3 is an above, exploded, partial view of an implementation of a lure 10 having a detachable wobble plate 40. In some implementations, the detachable wobble plate 40 is fixed to the shad body 20 through utilization of a screw 330 that is inserted into a threaded hole 320 and through a hole 310 in the wobble plate 40. However, no limitation upon the means of securing the wobble plate 40 to the shad body 20 should be assumed from this representation. For example, the wobble plate 40 could be fixed to the shad body 20 through other means such as a spring assembly (not shown) or permanently attached to the lure body.

In some implementations, the detachable wobble plate 40 enables a user to customize the behavior of the lure 10. For example, more pronounce wobble behavior can be imposed upon the lure 10 through larger and differently shaped wobble plates 40.

As shown in FIG. 4, one implementation of the fishing lure 11 (combination fishing lure) comprises a lure body 21 having a shad bait shape, a spinner attachment 31, a wobble plate 41, and fishing hooks 51. The lure body 21 is buoyantly positive. The lure body 21 is shaped such that the width (thickness) of the body is approximately equal to 12% to 25% of the length of the body. The entire assembly can be weighted such that when allowed to sink within a body of water, the leaf spoon or blade 101 and some portion of the spinner assembly 31 will rest upon the bottom of the body of the water while the lure body 21 rest upright with the wobble plate 41 at a higher elevation than the spinner assembly attachment point 111. During such a resting state, the weight of the hooks 51 cause the lure body 21 to remain upright. That is to say that the lure body 21 floats just above the bottom of the body of water, at an angle such that the wobble plate 41 is higher in elevation than the spinner attachment point 111, while some portion of the spinner assembly 31 rests on the bottom of the body of water.

The lure body 21 has a generally minnow shape including a top portion 60, a front portion 71, a bottom portion 76, and a rear portion 81. The lure body 21 is led by a wobble plate 41. The lure body 21 has a line attachment eye 121 for attachment to a fishing line. When pulled through the water, the wobble plate 41 generates a noise and causes some side to side movement. Additionally, when pulled through the water, the wobble plate 41 along with the combination of shapes of the lure body 21 create turbulence causing the fishing lure 11 to wobble both in the horizontal plane as well as the vertical plane. The spinner assembly 31 works to add drag upon the overall assembly, creating turbulence and a wake, noise, and a flashing image which serves to provide a stimulus, both in terms of motion and sound, to attract fish. The drag serves to help mitigate the wobbling of the fishing lure 11 causing a more natural like overall behavior. The leaf spoon 101 of the spinner assembly 31 rotates 360 degrees behind the lure body 21 and about an axis in a generally conical manner substantially parallel to that of the direction of pull upon the lure body 21.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations and/or components are depicted in the drawings in a particular order, this should not be understood as requiring that such operations or components be performed or fixed or assembled in the particular order shown or in sequential order, or that all illustrated operations or components be performed or present, to achieve desirable results. Moreover, the separation of various lure components in the embodiments described above should not be understood as requiring such separation in all embodiments or even any embodiment and it should be understood that the described components can generally be integrated together in a single lure.

Thus, particular embodiments of the subject matter have been described. Other embodiments are within the scope of the following claims.

1. A fishing lure, comprising:
a lure body composed of a buoyant material, the lure body having a first and second end; and
a spinner assembly, including a rigid blade, the assembly coupled to the second end of the lure body such that the rigid blade can freely rotate 360 degrees in a conical pattern behind the lure body as the lure body and attached spinner assembly is pulled through water.

2. The lure of claim 1, wherein the rigid blade is a leaf spinner.

3. The lure of claim 1, wherein an eye is located at the first end of the lure body for attaching a line and at least one hook is attached to the lure body.

4. The lure of claim 1, wherein the lure body has a shape corresponding to a shape selected from the group consisting of a shad lure, and a crank bait lure.

5. The lure of claim 1, wherein a wobble plate is affixed to the first end of the lure body.

6. The lure of claim 1, wherein the lure body and the spinner assembly have a combined density selected from the group consisting of less than the density of water, equal to the density of water, and greater than the density of water.

7. The lure of claim 6, wherein the combined density of the lure body and the spinner assembly is greater than the density of water and the rigid blade is adapted to spin and lead the lure body in sinking within the water.

8. The lure of claim 6, wherein the combined density of the lure body and the spinner assembly is equal to the density of water and the lure is adapted to remain suspended in the water at an initial level as a result of casting and dive while being pulled through the water.

9. A method for fishing comprising:
a) providing; (i) a fishing lure, including a lure body composed of a buoyant material, the lure body having a first and second end; (ii) a spinner assembly, including a rigid blade, the assembly coupled to the second end of the lure body such that the rigid blade can freely rotate 360 degrees behind the lure body as the lure body and attached spinner assembly is pulled through water; (iii) a wobble plate affixed to the first end of the lure body, and (iv) an eye located at the first end of the lure body for attaching a line;
wherein the fishing lure is attached to a fishing line through the eye wherein the line is installed on a fishing pole suitable for casting and reeling in the lure;
b) casting the lure into a body of water;
c) reeling the lure in.

10. The method of claim 9, wherein prior to reeling in the lure, the lure is allowed to rest in the water.

11. The method of claim 9 wherein reeling in the lure involves reeling in the lure without interruption at a generally constant speed.

12. The method of claim 9, wherein reeling in the lure involves reeling in the lure at a range of different speeds.

13. The method of claim 9, wherein reeling in the lure involves reeling in the lure with an intermittent stop and start motion.

14. A fishing lure, comprising:
a lure body, the lure body having first and second ends, the lure body composed of a buoyant material; and
a spinner assembly, including a metallic blade, coupled to a second end of the lure body such that a blade of the spinner assembly can freely rotate 360 degrees behind the lure body as the lure body and attached spinner assembly is pulled through water.

15. The lure of claim 14 wherein the lure body has the form of a shad bait.

16. The lure of claim 14 wherein the lure body has the form of a crank bait.

17. The lure of claim 14 wherein the spinner assembly is substantially more dense and heavier than the lure body such that the coupled lure body and spinner assembly sinks with the lure body trailing the spinner assembly as the whole sinks in a body of water.

18. The lure of claim 14 wherein the lure body has threaded, hollow cavities such that threaded inserts can be detachably inserted into said hollow cavities to modify the density of the lure body.

19. The lure of claim 14 wherein the lure body has a detachable wobble plate and a coating on the lure body.

20. The lure of claim 19, wherein the coating comprises an epoxy coating.
